(19) United States
(12) Patent Application Publication
(10) Pub. No.: US 2020/0142651 A1
(43) Pub. Date: May 7, 2020

(54) IMAGE FORMING APPARATUS, CONTROL METHOD THEREOF, AND STORAGE MEDIUM

(71) Applicant: CANON KABUSHIKI KAISHA, Tokyo (JP)

(72) Inventor: Kiyokazu Umimura, Kashiwa-shi (JP)

(21) Appl. No.: 16/671,495

(22) Filed: Nov. 1, 2019

(30) Foreign Application Priority Data
Nov. 7, 2018 (JP) 2018-209930

(51) Int. Cl. G06F 3/12; G06F 1/3206; G06F 1/28

(52) U.S. Cl. CPC G06F 3/1229; G06F 1/28; G06F 1/3206

(57) ABSTRACT

The present invention directs to an image forming apparatus comprising: a switch; a state holding unit that holds a state of the switch; a power supply control unit that controls power supply of the apparatus based on the state of the switch held by the state holding unit; and a monitoring unit that monitors a state of the state holding unit, wherein the power supply control unit controls power supply of the apparatus based on the state of the state holding unit.

### BACKGROUND OF THE INVENTION

### Field of the Invention

The present invention relates to an image forming apparatus, a control method thereof, and a storage medium.

### Description of the Related Art

In the related art, a main power switch used in an image forming apparatus is configured such that power is supplied and shut off in conjunction with a switch operation, like a seesaw switch. Thus, changing a seesaw switch from an on-state to an off-state enables power supply to a unit using high voltage, such as a printer of the image forming apparatus, to be immediately shut off.

Meanwhile, in recent years, an image forming apparatus is typically configured to perform power supply control for operation of a main power switch using software. Some image forming apparatuses configured to perform power supply control using software allow a power source to be turned on and off via a network. Thus, a push switch is used for a main power switch to change turning on and off of the main power switch by managing a power supply state with the software. For example, Japanese Patent Laid-Open No. 2014-79941 proposes that shutting off of power supply be controlled using software when a push switch is operated to change from an on-state to an off-state.

Unfortunately, the known technology described above has problems described below. In the above-described known technology, operation of the push switch by a user to change a power source of an image forming apparatus from an on-state to an off-state is detected using software. Upon detecting a switch operation by the user, the software determines a monitoring time in accordance with contents of the operation by the user and a power state, and starts a timer that clocks the monitoring time. Then, the software performs an operation of shutting off power supply or a reset operation when the timer expires. However, even with out-of-control software, the power supply of the image forming apparatus cannot be shut down until the monitoring time described above elapses after the operation by the user is received.

In addition, the push switch is not configured to hold its state by itself, so a unit holding the state (state holding unit) is required. However, when the unit holding the state fails, the power supply of the image forming apparatus cannot be accurately controlled in accordance with the state of the switch. When the power supply cannot be accurately controlled as described above, the power supply to a high voltage unit, such as a fixing device, for example, cannot be immediately shut off as needed, causing degradation and failure of each unit.

### SUMMARY OF THE INVENTION

The present invention enables realization of a mechanism in which power supply is controlled based on an operation of a switch and a state holding unit that holds a power supply state of an apparatus to suitably shut off power supply even when the state holding unit fails.

One aspect of the present invention provides an image forming apparatus comprising: a switch; a state holding unit that holds a state of the switch; a power supply control unit that controls power supply of the apparatus based on the state of the switch held by the state holding unit; and a monitoring unit that monitors a state of the state holding unit, wherein the power supply control unit controls power supply of the apparatus based on the state of the state holding unit.

Another aspect of the present invention provides a method for controlling an image forming apparatus including a switch, and a state holding unit that holds a state of the switch, the method comprising: controlling power supply of the apparatus based on the state of the switch held by the state holding unit; monitoring a state of the state holding unit; and controlling power supply of the apparatus based on the state of the state holding unit.

Still another aspect of the present invention provides a non-transitory computer-readable storage medium storing a computer program that causes a computer to execute each step of a method for controlling an image forming apparatus including a switch, and a state holding unit that holds a state of the switch, the method comprising: controlling power supply of the apparatus based on the state of the switch held by the state holding unit; monitoring a state of the state holding unit; and controlling power supply of the apparatus based on the state of the state holding unit.

Further features of the present invention will be apparent from the following description of exemplary embodiments with reference to the attached drawings.

### BRIEF DESCRIPTION OF THE DRAWINGS

FIG. 1 illustrates a system configuration of an information processing system according to an embodiment.

FIG. 2 is a block diagram illustrating a hardware configuration of an image forming apparatus according to an embodiment.

FIG. 3 illustrates a power source configuration of an image forming apparatus according to an embodiment.

FIG. 4 illustrates a configuration of a main power switch of an image forming apparatus according to an embodiment.

FIG. 5 is a flowchart illustrating operation of a state holding unit of an image forming apparatus according to an embodiment.

FIG. 6 is a flowchart illustrating operation of a monitoring unit of an image forming apparatus according to an embodiment.

FIG. 7 is a timing chart illustrating processing of an image forming apparatus according to an embodiment.

FIG. 8 is a flowchart illustrating operation of a monitoring unit of an image forming apparatus according to an embodiment.

FIG. 9 is a timing chart illustrating processing of an image forming apparatus according to an embodiment.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

As an example of an image forming apparatus according to an embodiment, a multi-function peripheral, i.e., a digital multi-function peripheral (MFP), will be described. However, the present invention can be applied to an electrophotographic image forming apparatus such as a laser printer or a FAX within a range without departing from the principles of the present invention. In addition, the present invention does not need to limit an object to be applied to an image forming apparatus, and can be applied to an information processing apparatus without an image forming function or an image processing function.

### First Embodiment

System Arrangement

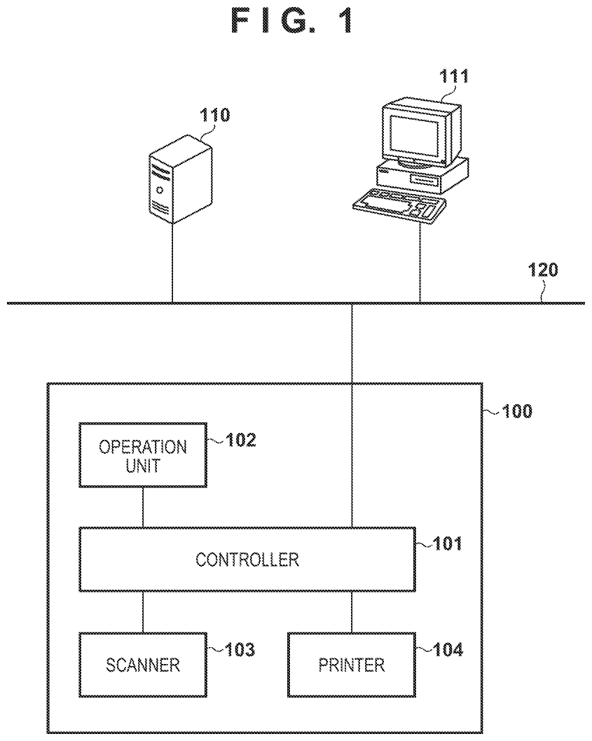

A first embodiment of the present invention will be described below with reference to the accompanying drawings. First, a system arrangement of an information processing system according to the present embodiment will be described with reference to FIG. 1.

The information processing system according to the present embodiment includes an image forming apparatus 100, a print server 110, and a client PC 111. Each apparatus is communicatively connected via a local area network (LAN) 120. Note that the present invention is not intended to be limited to the configuration above or the number thereof, and may include another apparatus.

The image forming apparatus 100 inputs and outputs, and transmits and receives, an image, and performs image processing associated with the image. The image forming apparatus 100 includes a controller 101, an operation unit 102 serving as a user interface, a scanner 103 serving as an image input device, and a printer 104 serving as an image output device. The operation unit 102, the scanner 103, and the printer 104 are each connected to the controller 101, and the controller 101 comprehensively controls operation of each unit. The controller 101 is connected to the LAN 120 via a network interface (I/F) 205 to communicate with the print server 110 and the client PC 111. At the client PC 111, a user creates a print job to print an image and instructs print processing. Accordingly, the print job is notified to the image forming apparatus 100 via the print server 110 and the LAN 120.

Configuration of Image Forming Apparatus

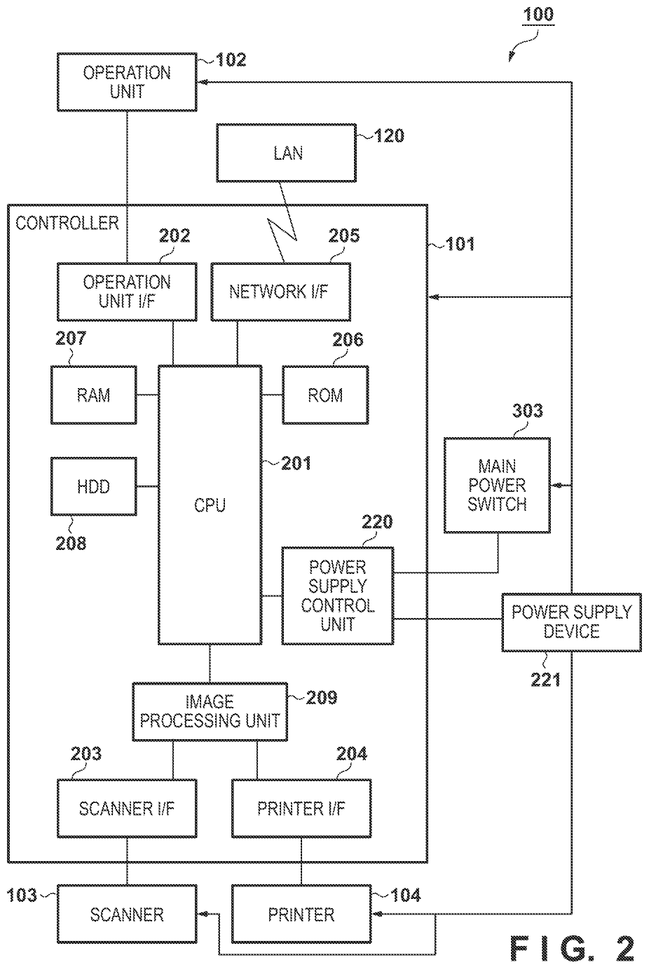

Next, a hardware configuration of the image forming apparatus according to the present embodiment will be described with reference to FIG. 2. In addition to the configuration described with reference to FIG. 1, the image forming apparatus 100 includes a power supply device 221 and a main power switch 303.

The controller 101 controls the scanner 103 connected to a scanner I/F 203, and the printer 104 connected to a printer LP 204. The controller 101 also inputs and outputs image data and device information to and from an external apparatus via the network I/F 205.

The controller 101 includes a central processing unit (CPU) 201 responsible for main control. The CPU 201 is connected to a read only memory (ROM) 206, a random access memory (RAM) 207, and a hard disk drive (HDD) 208 via a system bus. The CPU 201 is further connected to the network I/F 205 and an operation unit I/F 202.

The ROM 206 is a boot ROM and stores a startup program needed for system startup. For example, the ROM 206 stores a startup program for the CPU 201. The RAM 207 is a memory readable and writable as needed to provide a work area as a main storage unit of the CPU 201, and is also used as an image memory for temporarily storing image data to be internally processed. The HDD 208 is a non-volatile memory, and stores set value data, user data, and the like that need to be held even after power supply to an operating system, an application program, and the image forming apparatus 100 is shut off. When the CPU 201 executes processing according to programs stored in the ROM 206, the HDD 208, and the like, functions of the image forming apparatus 100 are implemented.

The network I/F 205 is an interface for connection with the LAN 120, and inputs and outputs data to and from the LAN 120. The operation unit I/F 202 is an interface for inputting and outputting information to and from the operation unit 102 composed of a liquid crystal touch panel or the like. The CPU 201 outputs image data to be displayed to the operation unit 102 via the operation unit I/F 202. The operation unit I/F 202 transfers data input by a user via the operation unit 102 to the CPU 201.

The scanner I/F 203 and the printer I/F 204 are interfaces that respectively connect the scanner 103 and the printer 104 to the controller 101. The image processing unit 209 is connected to the CPU 201, the scanner I/F 203, and the printer I/F 204. The image processing unit 209 performs image processing, such as correction, processing, and editing, on input image data read using the scanner 103. Then, the image processing unit 209 performs processing, such as color conversion, filtering, resolution conversion, or the like, on print output image data to be output to the printer 104.

A power supply control unit 220 changes turning on and off of power supply to each unit in accordance with an operation state of the image forming apparatus 100. The power supply control unit 220 receives a control signal from the CPU 201 via the system bus, and transmits a control signal to the power supply device 221 in response to the received control signal to control power supply. The power supply device 221 receives power supply from a commercial power supply 301, and supplies power to each unit of the image forming apparatus 100 in response to the control signal received from the power supply control unit 220.

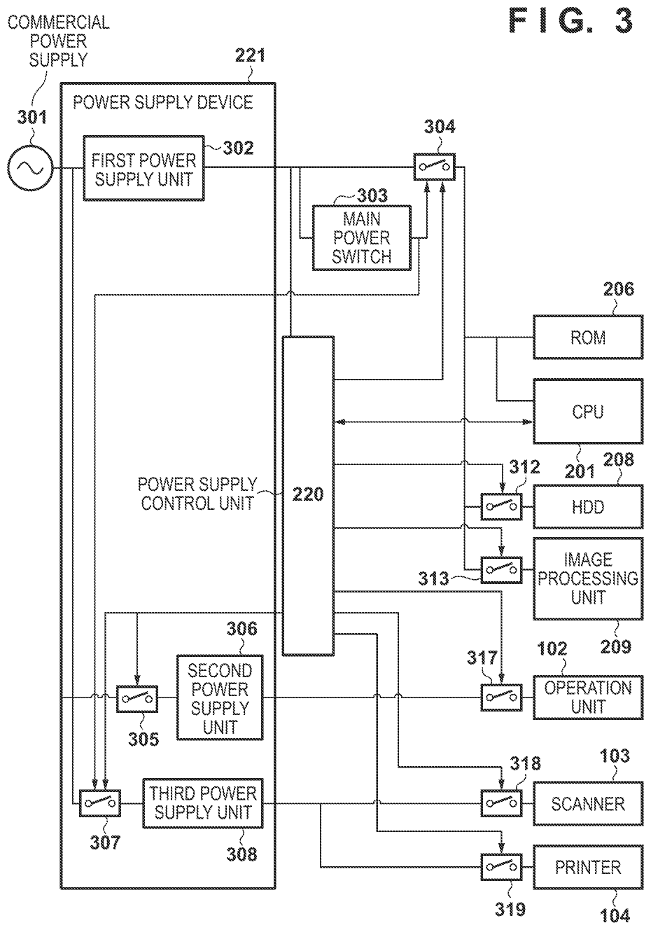

The power supply device 221 is constantly energized as long as it is connected to the commercial power supply 301 with a power supply cable to enable the supply of power. The power supply device 221 includes a power supply circuit composed of a first power supply unit 302, a second power supply unit 306, and a third power supply unit 308, illustrated in FIG. 3, to supply DC power to each unit of the image forming apparatus 100.

The main power switch 303 is a switch for changing an operation state of the image forming apparatus 100. Each time the main power switch 303 is operated, an output signal value toggles to change a power supply state of the image forming apparatus 100. When the main power switch 303 is operated in a power supply state of the image forming apparatus 100 being an off-state, the power supply state can be changed to an on-state. In the on-state, the first power supply unit 302, the second power supply unit 306, and the third power supply unit 308 supply power to allow the image forming apparatus 100 to be in an operation state capable of forming an image. On the other hand, when the main power switch 303 is operated in a power supply state of the image forming apparatus 100, being the on-state, the power supply state can be changed to the off-state. In the off-state, power supply of the second power supply unit 306 and the third power supply unit 308, and power supply to the controller 101, are shut off to stop the operation of the image forming apparatus 100.

Power Supply Configuration

Next, a power supply configuration of the image forming apparatus 100 according to the present embodiment will be described with reference to FIG. 3. The power supply device 221 includes the first power supply unit 302, the second power supply unit 306, the third power supply unit 308, and switches 305 and 307. The power supply device 221 is connected to the power supply control unit 220, the commercial power supply 301, the main power switch 303, and switches 304, 312, 313, 317, 318, and 319.

Upon detecting an operation by a user, the main power switch 303 turns on the switch 304 to supply power to the CPU 201. Then, the CPU 201 notifies the power supply control unit 220 that the power is supplied to the CPU 201. When finding that the power is supplied to the CPU 201, the power supply control unit 220 turns on the switches 305, 307, 312, 313, and 317 to 319 to supply power to each unit of the image forming apparatus 100. Then, the CPU 201 performs startup processing according to a startup program stored in the ROM 206, so that the image forming apparatus 100 transitions to the operation state capable of forming an image.

The image forming apparatus 100 includes, as a power supply state, an operating state and a power saving state. In the operating state, the power supply device 221 supplies power to the controller 101, the operation unit 102, the scanner 103, and the printer 104. The CPU 201 transmits a control signal via the system bus to rewrite a register value stored inside the power supply control unit 220. The power supply control unit 220 controls turning on and off of each of the switches 304, 305, 307, 312, 313, and 317 to 319 to control power supply to each unit in accordance with the register value rewritten. In the operating state, a user can use functions, such as scanning and printing, of the image forming apparatus 100.

In the power saving state, the power supply device 221 supplies power to the power supply control unit 220. The CPU 201 also controls the power control unit 220 so as to enable power supply to a part of the controller 101 and disable power supply to the operation unit 102, the scanner 103, and the printer 104. The power supply control unit 220 turns off the switches 312, 313, and 317 to 319, connected to a power supply line, to shut off power supply. Then, the switches 305 and 307 are turned off to turn off the second power supply unit 306 and the third power supply unit 308, so that standby power consumption of the second power supply unit 306 and the third power supply 308 is reduced. In the power saving state, the image forming apparatus 100 transitions to the operating state when the power supply control unit 220 detects that a user depresses a button of the operation unit 102, and that data is received from the network, for example.

Configuration of Main Power Switch

Next, a configuration of the main power switch 303 according to the present embodiment will be described with reference to FIG. 4. The main power switch 303 includes a push switch 401, a state holding unit 402, a monitoring unit 403, and an AND circuit 404. When the push switch 401 is turned on by a user operation, the push switch 401 enters a conductive state and signals are transmitted to the state holding unit 402 and the monitoring unit 403 connected subsequent to the push switch 401. Then, a signal from the state holding unit 402 and a signal from the monitoring unit 403 are input to the AND circuit 404, and a logical AND of these signals is input to the power supply control unit 220 as an output from the AND circuit 404. The output from the state holding unit 402 is any one of a High-level signal indicating that the main power switch 303 is in an on-state (power-on state) and a Low-level signal indicating that the main power switch 303 is in an off-state (power-off state). The output from the monitoring unit 403 is also a High-level signal or a Low-level signal. When receiving the High-level signal from each of the state holding unit 402 and the monitoring unit 403, the AND circuit 404 outputs the High-level signal indicating that the main power switch 303 is in an on-state. Otherwise, the AND circuit 404 outputs the Low level signal indicating that the main power switch 303 is in an off-state.

The push switch 401 is turned on while being depressed by a user, and is turned off when depression is ceased, and thus cannot be held in an on-state and an off-state. Thus, the image forming apparatus 100 is configured such that the state holding unit 402 holds the on-state and the off-state of the main power switch 303. Then, the state holding unit 402 outputs a signal (High-level signal or Low-level signal) at a level corresponding to a held state. When the push switch 401 is operated in a held state being the off-state, the state holding unit 402 accordingly changes the held state to the on-state and outputs a High-level signal. On the other hand, when the push switch 401 is operated in a held state being the on-state, the state holding unit 402 accordingly changes the held state to the off-state and outputs a Low-level signal.

In addition, the monitoring unit 403 monitors, as a safety measure when the state holding unit 402 fails, whether a signal output from the state holding unit 402 changes when a predetermined time elapses after a detecting operation on the push switch 401. The monitoring unit 403 includes a circuit that masks an output of the main power switch 303 in place of the state holding unit 402 when the signal output does not change within the predetermined time and a failure of the state holding unit 402 is detected. In other words, the monitoring unit 403 can force power supply in the apparatus to be changed to the off-state by masking the output of the main power switch 303. Specifically, the monitoring unit 403 outputs a Low-level signal to the AND circuit 404 to mask an output of a High-level signal, indicating that the main power switch 303 is in the on-state (i.e., the AND circuit 404 is caused to output a Low-level signal).

While in the present embodiment, an example in which the state holding unit 402 and the monitoring unit 403 are provided as a configuration in the main power switch 303, the present invention is not intended to be limited to such a configuration. That is, the state holding unit 402 and the monitoring unit 403 are not required to be provided in the main power switch 303, and may be provided as an external configuration.

Operation of State Holding Unit

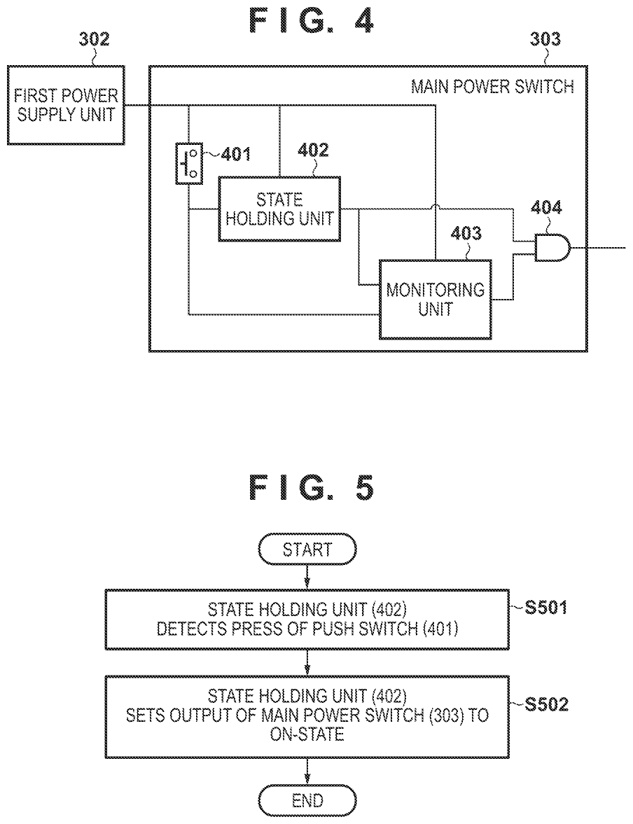

Next, a processing procedure when the main power switch 303 is changed from the off-state to the on-state in the image forming apparatus 100 according to the present embodiment will be described with reference to FIG. 5. Here, an operation of the state holding unit 402 holding the off-state an initial value, when the push switch 401 has been depressed, will be described.

First, at S501, the state holding unit 402 detects that the push switch 401 has been depressed in the off-state. Subsequently, at S502, the state holding unit 402 changes an output of the main power switch 303 to that of the on-state. When the main power switch 303 enters the on-state, the switch 304 enters a conductive state and the CPU 201 is energized, and then startup processing starts.

On the other hand, operation of changing from the on-state to the off-state is performed such that the state holding unit 402 detects that the push switch 401 has been depressed while the main power switch 303 is in the on-state, and changes an output of the main power switch 303 to that of the off-state. When the main power switch 303 enters the off-state, the switch 307 is turned off, the third power supply unit 308 is turned off, and the scanner 103 and the printer 104 are powered off, forcibly being turned off. Then, the CPU201 performs end processing, and instructs the power control unit 220 to turn off the second power supply unit 306 and the switch 304. When the switch 304 is turned off, the CPU 201 is powered off.

Next, operation of the state holding unit 402 when it fails will be described. When detecting a failure of the state holding unit 402, the monitoring unit 403 changes an output of the main power switch 303 to that of the off-state by masking an output signal from the main power switch 303 with the mask circuit. Likewise, when the monitoring unit 403 changes the output of the main power switch 303 to that of the off-state, the switch 307 is turned off, the third power supply unit 308 is turned off, and the scanner 103 and the printer 104 are powered off to be forcibly turned off.

Operation of Monitoring Unit

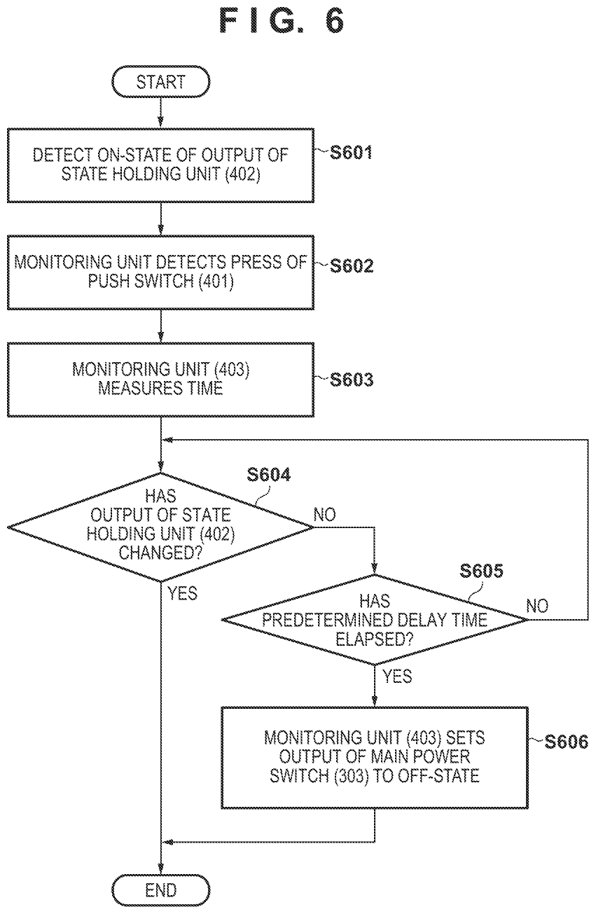

Next, an operation in which the monitoring unit 403 detects a failure of the state holding unit 402, according to the present embodiment, will be described with reference to FIG. 6. Here, an operation when output of the main power switch 303 is an on-state and the state holding unit 402 fails will be described.

At S601, the monitoring unit 403 detects the on-state from logic of an output signal of the state holding unit 402. Then, at S602, the monitoring unit 403 detects that the push switch 401 has been depressed by a user. Here, the push switch 401 is connected on one side to the first power supply unit 302, so that the push switch 401 enters a conductive state when depressed. Accordingly, logic of a signal to be input to the monitoring unit 403 is changed. Upon receiving the change in the logic of the input signal from the push switch 401, the monitoring unit 403 detects that the push switch 401 has been depressed.

Next, at S603, the monitoring unit 403 clocks an elapsed time from a point in time when the push switch 401 is depressed. To check whether the state holding unit 402 fails, the monitoring unit 403 preliminarily retains a delay time until output of the state holding unit 402 changes after the push switch 401 is depressed. Then, to check that the output of the state holding unit 402 changes until elapse of the delay time, the clocking starts at S603.

The state holding unit 402 is here composed of a flip-flop or the like for holing a state, and a delay time of 1 μs is assumed as the time until the output changes. However, the delay time is dependent on a configuration, and thus is not limited to 1 μs.

At S604, the monitoring unit 403 determines whether an output signal of the state holding unit 402 changes in logic when the push switch 401 has been depressed. When the output signal of the state holding unit 402 changes in the logic, it is determined that the state holding unit 402 operates normally, and then processing ends.

On the other hand, when the output signal does not change in logic due to a failure of the state holding unit 402, the processing proceeds to S605. Then the monitoring unit 403 determines whether a predetermined delay time elapses without changing in the output signal of the state holding unit 402. When the predetermined delay time elapses, it is determined that the state holding unit 402 fails, and then the processing proceeds to S606. When the predetermined delay time does not elapse, the processing returns to S604.

At S606, the monitoring unit 403 enables the mask to allow the output of the main power switch 303 to enter the off-state. Then, the monitoring unit 403 continues the off-state for the output of the main power switch 303 regardless of whether a user operates the push switch 401. Accordingly, even when a switch operation from the off-state to the on-state is performed during a failure of the state holding unit 402, power can be controlled so as not to be supplied.

Timing Chart

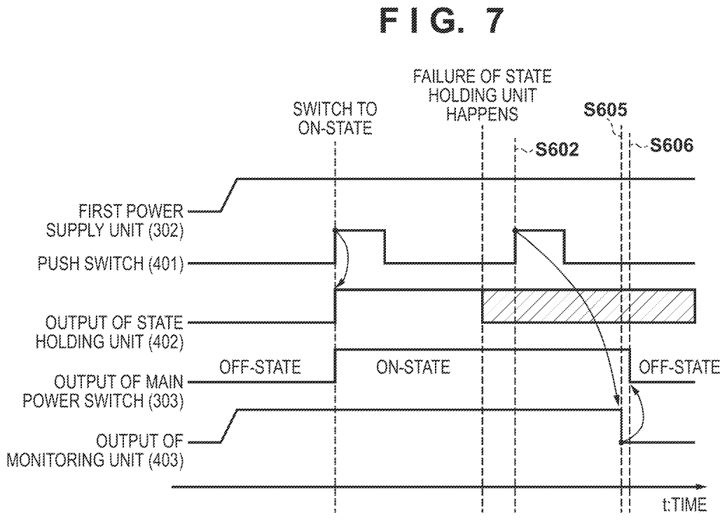

Next, change of a signal in the present embodiment will be described with reference to FIG. 7. In FIG. 7, the horizontal axis indicates time, and the vertical axis indicates signal values of each unit. The main power switch 303 has an initial state of an off-state. Upon detecting depressing on the push switch 401, the state holding unit 402 changes to an on-state. Accordingly, output of the main power switch 303 also enters an on-state.

Then, it is assumed that the state holding unit 402 fails. In this case, the monitoring unit 403 detects that the push switch 401 has been depressed by a user (S602). Then, when output of the state holding unit 402 is not changed (S605) even after an elapse of a delay time, the monitoring unit 403 forces the output of the main power switch 303 to be changed to the off-state (S606).

As described above, the image forming apparatus according to the present embodiment includes the switch that changes a power supply state of the apparatus, and the state holding unit that holds the power supply state of the apparatus in accordance with a user operation on the switch. The image forming apparatus also controls power supply of the apparatus in accordance with a power supply state held by the state holding unit, and monitors a power supply state held by the state holding unit in accordance with the user operation on the switch. In addition, upon detecting that a user operates the switch in the power supply state held by the state holding unit, indicating the on-state, the image forming apparatus changes the power supply state to a state indicating the off-state. Thus, when the user operates the main power switch 303 to change its state to the off-state, the scanner 103 and the printer 104 of the image forming apparatus 100 can be turned off in response to the operation even with the state holding unit 402 having failed. This enables immediately shutting off power supply to a portion with high voltage inside the printer 104, for example.

The image forming apparatus according to the present embodiment also may be configured such that upon detecting that a user operates the switch in the power supply state held by the state holding unit, indicating the on-state, the image forming apparatus changes the power supply state to a state indicating the off-state after an elapse of a predetermined time. In addition, even after the elapse of a predetermined time after a user operates the switch in a power supply state held by the state holding unit, indicating the on-state, when the power supply state held by the state holding unit does not change, the image forming apparatus according to the present embodiment may change the power supply state to a state indicating the off-state.

### Second Embodiment

Hereinafter, a second embodiment of the present invention will be described. In the present embodiment, a configuration is described in which the monitoring unit 403 determines an operation on a switch with an elapse of a predetermined time as a long press to forcibly control the power supply into an off-state. Description of a configuration and control similar to those of the first embodiment will be eliminated. The long press on the switch is performed when a user intentionally forcibly terminates the apparatus.

Operation of Monitoring Unit

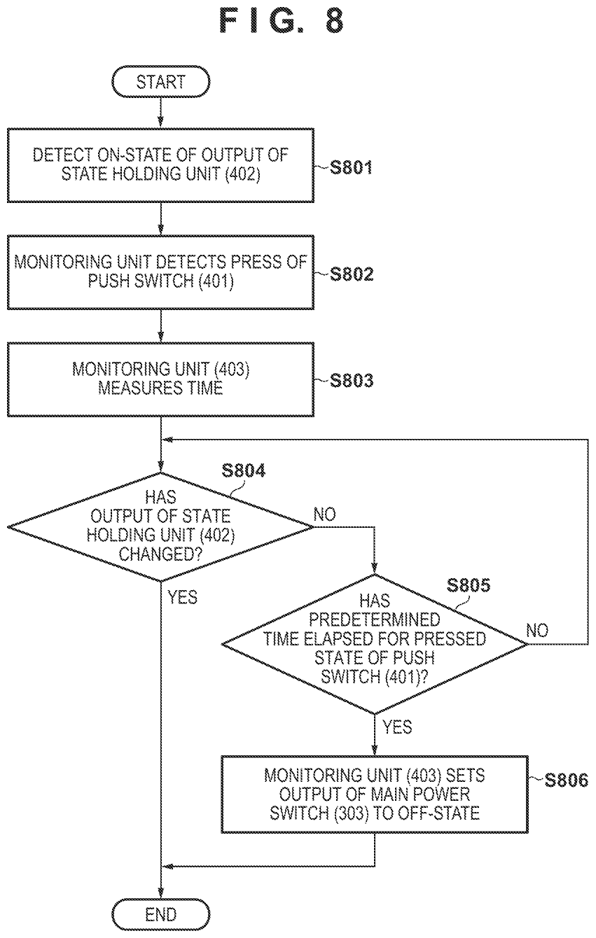

First, an operation in which the monitoring unit 403 detects the long press on the state holding unit 402, according to the present embodiment, will be described with reference to FIG. 8. Here, an operation when output of the main power switch 303 is turned on and the state holding unit 402 fails will be described. A step at which the state holding unit 402 operates normally is similar to that in FIG. 6, and thus duplicated description is eliminated. In processing described below, control different from that of FIG. 6 will be mainly described.

At S801, the monitoring unit 403 detects the on-state from logic of an output signal of the state holding unit 402. Then, at S802, the monitoring unit 403 detects the long press on the push switch 401. Here, upon receiving change in logic of an input signal from the push switch 401, the monitoring unit 403 detects the long press on the push switch 401.

Next, at S803, the monitoring unit 403 clocks an elapsed time (operation time) from a point in time when the push switch 401 is depressed. Here, the state holding unit 402 has a delay time until its output is changed, so that a time for determining the long press on the push switch 401 needs to be set longer than the delay time of the state holding unit 402. Thus, the predetermined time (operation time) to be clocked here is longer than the delay time described in the first embodiment.

At S804, the monitoring unit 403 determines whether an output signal of the state holding unit 402 changes in logic when the push switch 401 has been depressed. When the output signal of the state holding unit 402 changes in the logic, it is determined that the state holding unit 402 operates normally, and then the processing ends.

On the other hand, when the output signal does not change in logic due to a failure of the state holding unit 402, the processing proceeds to S805, and then the monitoring unit 403 determines whether a predetermined time elapses in a state with the push switch 401 depressed. When the predetermined time elapses, it is determined that the long press is there, and then the processing proceeds to S806. At S806, the monitoring unit 403 enables a mask to allow the output of the main power switch 303 to enter an off-state. Then, the monitoring unit 403 continues the off-state for the output of the main power switch 303 regardless of whether a user operates the push switch 401. Accordingly, even when a switch operation from the off-state to the on-state is performed during a failure of the state holding unit 402, power can be controlled so as not to be supplied.

Timing Chart

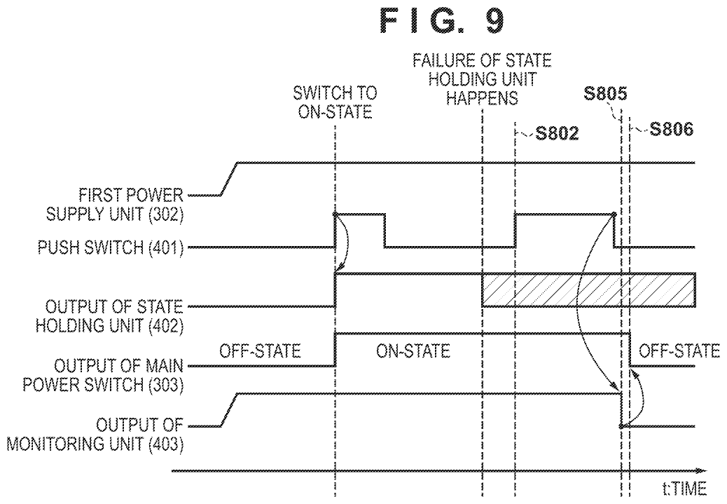

Next, change of a signal in the present embodiment will be described with reference to FIG. 9. In FIG. 9, the horizontal axis indicates time, and the vertical axis indicates signal values of each unit. A portion where the main power switch 303 is changed from the off-state to the on-state is similar to that in FIG. 7, so that detailed description thereof will be eliminated.

When the state holding unit 402 fails, the monitoring unit 403 detects that the push switch 401 has been depressed by the user, and clocks time in which the push switch 401 is depressed. When output of the state holding unit 402 is not changed (S805) even after an elapse of a predetermined time, the monitoring unit 403 forces the output of the main power switch 303 to be changed to the off-state (S806).

As described above, when a user operates with the long press on the main power switch 303 to forcibly change its state to the off-state, the scanner 103 and the printer 104 of the image forming apparatus 100 can be turned off in response to the operation even with the state holding unit 402 having failed. This enables immediately shutting off power supply to a portion with high voltage inside the printer 104, for example.

### Third Embodiment

Hereinafter, a third embodiment of the present invention will be described. In the present embodiment, the monitoring unit 403 monitors logic (High-level or Low-level) of an output signal of the state holding unit 402. When detecting depressing on the push switch 401 with the output signal of the state holding unit 402 having the logic of the on-state (High-level), the monitoring unit 403 outputs a Low-level signal to the AND circuit 404 after an elapse of a predetermined time from an operation on the push switch 401. Accordingly, the output of the main power switch 303 also enters an off-state (Low-level). Depressing on the push switch 401 is detected when the monitoring unit 403 receives change in logic of an input signal from the push switch 401. Accordingly, even when the state holding unit 402 fails, power supply can be turned off.

When the state holding unit 402 constantly outputs a signal indicating the on-state (High-level) due to its failure, the monitoring unit 403 outputs the Low-level signal even when the push switch 401 is depressed multiple times. Thus, when the state holding unit 402 fails, the output of the main power switch 303 does not change from the off-state to the on-state (High-level), and thus the image forming apparatus 100 can be prevented from entering an on-state while having a failure. When detecting depressing of the push switch 401 with the output signal of the state holding unit 402 having the logic of the off-state (Low-level), the monitoring unit 403 according to the present embodiment outputs a High-level signal to the AND circuit 404. In addition, when the state holding unit 402 outputting the Low level signal while holding the off-state is normal, the state holding unit 402 will hold the on-state and output a High-level signal. Thus, when the state holding unit 402 is normal, the output of the main power switch 303 can be changed from the off-state (Low-level) to the on-state (High-level). On the other hand, when the state holding unit 402 has a failure causing the off-state to be constantly held and the Low-level signal to be output, the output of the main power switch 303 does not change from the off-state to the on-state, and thus the image forming apparatus 100 can be prevented from entering the on-state while having a failure.

As described above, according to the third embodiment, the monitoring unit 403 can turn off power supply of the image forming apparatus 100 without monitoring change in the logic of the output signal of the state holding unit 402.

### Other Embodiments

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-209930 filed on Nov. 7, 2018, which is hereby incorporated by reference herein in its entirety.

What is claimed is:

1. An image forming apparatus comprising:
a switch;
a state holding unit that holds a state of the switch;
a power supply control unit that controls power supply of the apparatus based on the state of the switch held by the state holding unit; and
a monitoring unit that monitors a state of the state holding unit,
wherein the power supply control unit controls power supply of the apparatus based on the state of the state holding unit.

2. The image forming apparatus according to claim 1, wherein
the power supply control unit controls power supply of the apparatus based on the state of the state holding unit when an elapse of a predetermined time after the switch is operated.

3. The image forming apparatus according to claim 2, wherein
the power supply control unit controls power supply of the apparatus if the state held by the state holding unit does not change even if the elapse of the predetermined time after the switch is operated.

4. The image forming apparatus according to claim 3, wherein
the state holding unit outputs, to the power supply control unit, a signal corresponding to the state of the switch,
the power supply control unit controls the power supply of the apparatus in accordance with the signal output by the state holding unit,
the monitoring unit monitors the signal output from the state holding unit, and
the power supply control unit controls power supply of the apparatus if the signal output from the state holding unit does not change even if the elapse of the predetermined time after the switch is operated.

5. The image forming apparatus according to claim 4, wherein
the predetermined time is a delay time from a user operation on the switch until a signal output from the state holding unit changes.

6. The image forming apparatus according to claim 5, wherein
the predetermined time is an operation time for determining that a user operation on the switch is a long press.

7. The image forming apparatus according to claim 6, wherein
the operation time is longer than the delay time.

8. The image forming apparatus according to claim 1, wherein
the switch is a push switch.

9. The image forming apparatus according to claim 1, wherein
even when a user operates the switch, again, after the state of the switch is changed to a state indicating the off-state, the monitoring unit continues the off-state of the state of the switch.

10. A method for controlling an image forming apparatus including a switch, and a state holding unit that holds a state of the switch, the method comprising:
controlling power supply of the apparatus based on the state of the switch held by the state holding unit;
monitoring a state of the state holding unit; and
controlling power supply of the apparatus based on the state of the state holding unit.

11. A non-transitory computer-readable storage medium storing a computer program that causes a computer to execute each step of a method for controlling an image forming apparatus including a switch, and a state holding unit that holds a state of the switch, the method comprising:
controlling power supply of the apparatus based on the state of the switch held by the state holding unit;
monitoring a state of the state holding unit; and
controlling power supply of the apparatus based on the state of the state holding unit.
